(19) United States
(12) Patent Application Publication
(10) Pub. No.: US 2010/0212453 A1
(43) Pub. Date: Aug. 26, 2010

(54) VIBRATION REDUCING GRIP AND CONNECTOR

(76) Inventor: Benoit ROUILLARD, Quebec (CA)

Correspondence Address: GOUDREAU GAGE DUBUC, 2000 MCGILL COLLEGE, SUITE 2200, MONTREAL, QC, H3A 3H3, CA

(21) Appl. No.: 12/709,008

(22) Filed: Feb. 19, 2010

Related U.S. Application Data
(60) Provisional application No. 61/154,469, filed on Feb. 23, 2009.

(51) Int. Cl. B62K 21/26

(52) U.S. Cl. 74/551.9

(57) ABSTRACT

A vibration reducing grip for a handle bar having an outer tubular element; an inner tubular element disposed within said outer tubular element; and a vibration reducing coupling comprising a plurality of deformable ribs for coupling said inner tubular element and said outer tubular element. The vibration imparted from the handle bar is reduced by the deformation of the vibration reducing coupling.

This application claims priority, under 35 U.S.C. §119(e), on U.S. provisional patent application Ser. No. 61/154,469, filed on Feb. 23, 2009, which is incorporated by reference in its entirety.

### FIELD OF THE INVENTION

The present invention relates to a vibration dampening handlebar grip and connector. More specifically, the present invention is concerned with a vibration reducing grip and connector for vibrating screed.

### BACKGROUND OF THE INVENTION

There is known in the prior art vibrating screeds comprising, for instance, an elongated blade connected at lower ends of a pair of handles adapted to be hand held and operated for displacing the screed over a concrete surface. A motor is provided above such blade and between the handles for imparting oscillatory movement to the blade of high frequency but low amplitude. Generally, such devices are guided and controlled by one or two handlebar means gripped by an operator.

The operation of such devices usually occurs over many hours during which period vibrations from the oscillatory movement of the blade is transferred to the operator through handlebar grips leading to increased operator fatigue and strain. The prior art discloses handlebar grips which can reduce such vibration. For example, U.S. Pat. No. 6,296,467 discloses a handlebar means with textured rubber grip members attached thereto. Additionally, US 2005/0211569 discloses a vibration reducing grip comprising an encasing member filled with flowable particulate matter wherein vibration is reduced by the encasing member. However, the prior art fails to teach of a vibration reducing grip having an entire structure contributing to vibration reduction that is simpler and employs gas and a deformable structure to absorb shock. There is therefore a need for a vibration dampening handlebar grip and connector to reduce the vibration transfers from a handlebar to an operator.

### SUMMARY OF THE INVENTION

According to the present invention, there is provided a vibration reducing grip for a handle bar comprising: an outer tubular element; an inner tubular element disposed within said outer tubular element; and a vibration reducing coupling comprising a plurality of deformable ribs for coupling said inner tubular element and said outer tubular element; wherein vibration imparted from the handle bar is reduced by the deformation of the vibration reducing coupling; wherein vibration imparted from the handle bar is reduced by the deformation of the vibration reducing coupling.

### BRIEF DESCRIPTION OF THE DRAWINGS

In the appended drawings:

FIG. 1 is a perspective view of a handlebar comprising a vibration reducing handlebar grip and handlebar assembly link, according to a preferred embodiment of the present invention;

FIG. 2 is a perspective view of the vibration reducing handlebar grip shown in FIG. 1;

FIG. 3 is a longitudinal sectional view of the vibration reducing handlebar grip of FIG. 2;

FIG. 4 is a cross-sectional view of the handlebar grip of FIG. 2 wherein the section plane is indicated by the arrows B-B of FIG. 3;

FIG. 5 is an exploded view of the handlebar grip of in FIG. 2, with a handlebar assembly linkage and connection components;

FIG. 6 is a cross-sectional view of the handlebar assembly linkage in FIG. 5;

FIG. 7 is a longitudinal sectional view of the handlebar grip of FIG. 5 with handlebar assembly linkage and connection components engaged thereto wherein the section plane is indicated by the arrows B-B of FIG. 6.

FIG. 8 is a cross-sectional view of the handlebar grip of FIG. 2 wherein the section plane is indicated by the arrows C-C of FIG. 3;

### DESCRIPTION OF ILLUSTRATIVE EMBODIMENTS

The present invention is illustrated in further detail by the following non-limiting example.

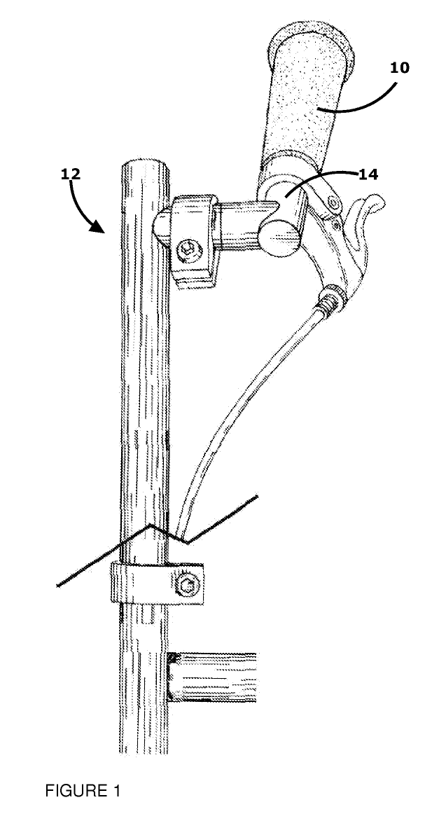

Referring to FIG. 1, a vibration reducing grip in accordance with an illustrative embodiment of the present invention will be described. The vibration reducing grip, generally referred to using the reference numeral 10, which serves to reduce vibration emanating from a handlebar assembly 12 of a vibrating screed is disclosed.

Still referring to FIG. 1, there is shown a handlebar assembly 12 for a vibrating screed (not shown) comprising a vibration reducing grip 10 and a handlebar assembly link 14, according to a preferred embodiment of the present invention.

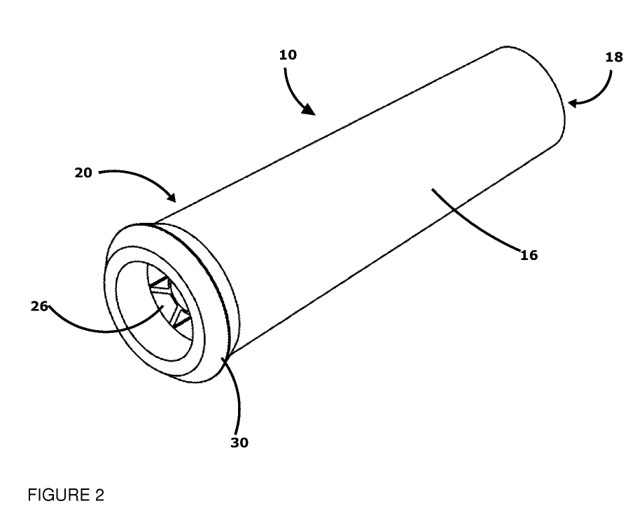

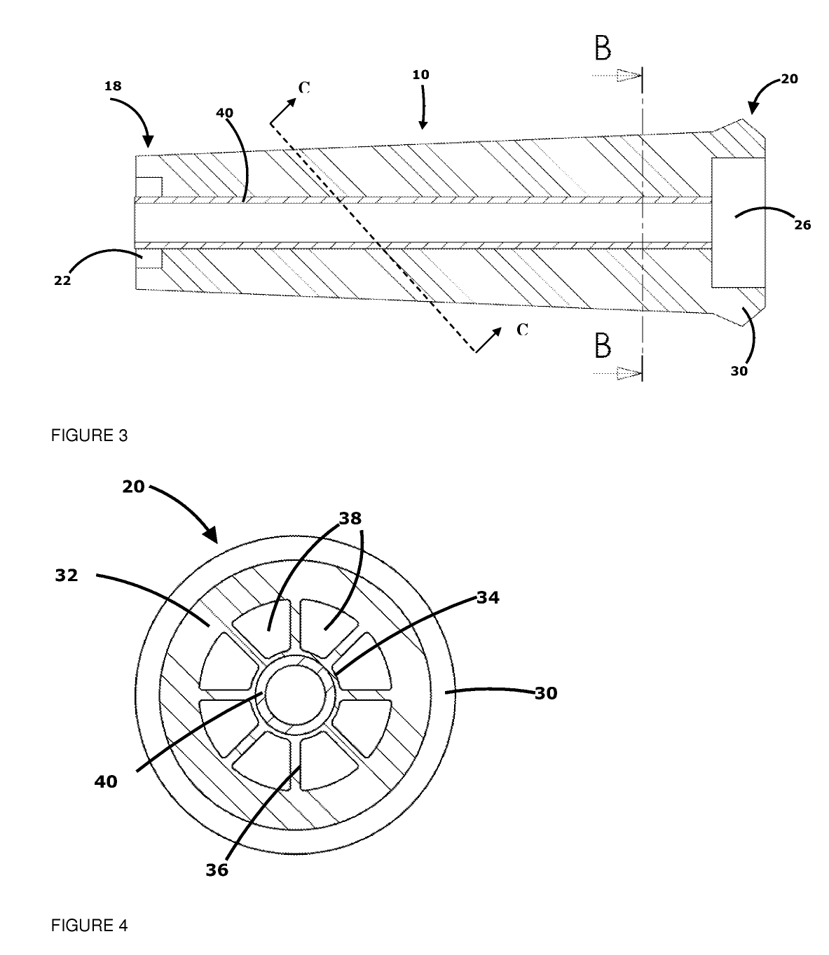

Now referring to FIGS. 2 and 3, in addition to FIG. 1, there is shown a vibration reducing grip 10 including a tubular element 16 having a smaller diameter at a first end 18 and a larger diameter at a second end 20 and tapering in diameter over its length from the second end 20 to the first end 18.

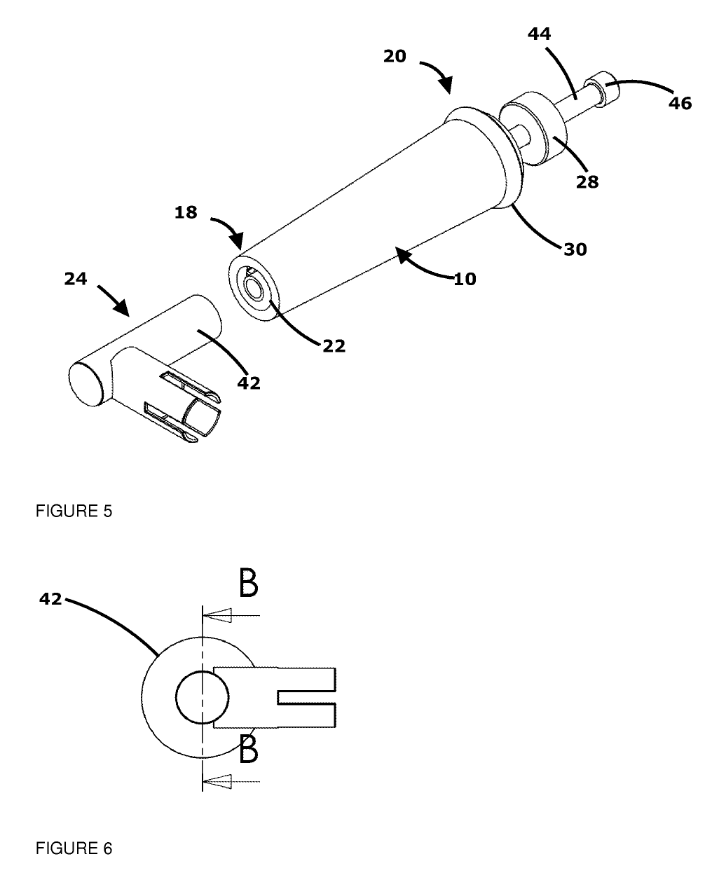

Referring to FIGS. 3 and 5, in addition to FIG. 2, the first end 18 has a recess 22 designed to receive a handlebar assembly end 24. Similarly, the second end 20 has a second recess 26 designed to receive a cap ring 28. The second end 20 preferably includes an annular flange 30 about its circumferential end.

Now referring to FIG. 4, in addition to FIG. 2, the tubular element 16 comprises an outer tubular member 32 and an inner tubular member 34, which are coupled together by rib members 36. The outer 32, inner 34 and rib members 36 are made of a deformable material, such as synthetic and natural rubber, thermoplastic elastomers, thermoplastic resins, polyester, elastomer and plastic reinforced textiles, polyurethane or any other deformable material known to a person skilled in the art. Additionally the outer 32, inner 34 and rib members 36 can be formed as a singular body through molding for example. The inner member 34, the outer member 32 along with rib members 36 cooperate to define deformable compartments 38 having hysteresis characteristics. Hysteresis is known as the tendency for otherwise elastic materials to rebound with less force than was required to deform them. The compartments 38 are normally filled with air, but in a different embodiment they are filled with filler material and/or a gas and sealed therein. For example, when the compartments are filled with air or gas, the air or gas compresses by the deformation of the compartments due to the shock energy travelling there through and expands when the shock energy ceases. The work required to compress the gas or air absorbs a portion of the shock energy.

The rib members 36 preferably include ribs running longitudinally to the length of deformable inner tubular member 34 and extending radially and perpendicularly outward between the inner tubular members 34 and outer tubular members 32. These rib members 36 are spaced apart in such a configuration as to form a support between these elements. Adjacent and concentric to the inner member 19, there is a hollow tubular element 40 of smaller diameter, which is preferably made of metallic material. In operation, vibration propagating from a handlebar assembly 12 through a vibration reducing grip 10 absorbed and reduced by the deformation of the hollow compartments 38 and the compression of the gas or air therein.

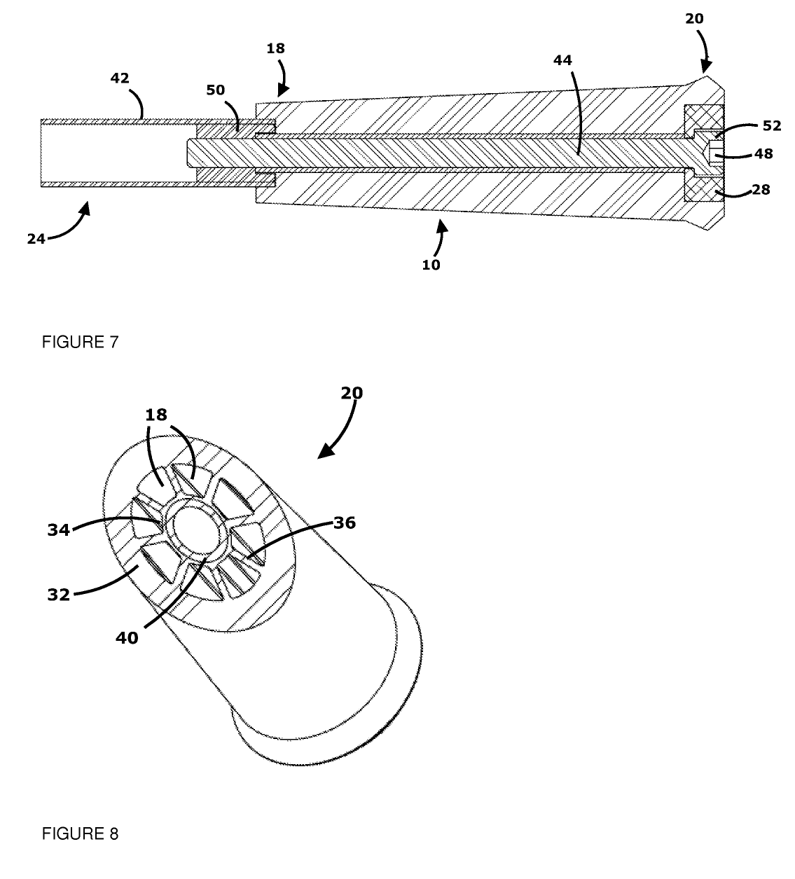

Referring to FIGS. 6 and 7, in addition to FIG. 5, the vibration reducing grip 10 is designed to receive, at the first end 18 of the grip 10, a handlebar end 42 of the handlebar assembly link 24 and securely connect the vibration reducing grip 10 to a handlebar assembly link 24. Similarly, the cap ring 28 and the hollow tubular element 40 are designed to receive, at the second end 20 of the grip 10, a connection rod 44 comprising a flange 46 and a securing bolt 48 for securing the cap ring 28 and flange 46 within the recess 26. The connection rod 44 is slid through hollow tubular element 40 to engage a vibration reducing coupling 50 residing within the handlebar end 42 of handlebar assembly link 24. The vibration reducing coupling 50 is comprised of such material as synthetic and natural rubber, thermoplastic elastomers, thermoplastic resins, polyester, elastomer and plastic reinforced textiles, polyurethane or any other deformable material known to a person skilled in the art.

Referring to FIG. 7, the vibration reducing grip 10 and the handlebar assembly link 24 are shown engaged with one another. In comparison to FIG. 5, the connection rod's flange 46 abuts the cap ring 28. The cap ring 28 is received within the second recess 26 of second end 20 of the grip 10 thereby sealing the second end opening defined between the outer tubular member 32 and the inner tubular member 34. In a different embodiment, the cap ring 28 receives the flange 46 of connection rod 44 within a third recess 52 within the cap ring 28. The connection rod 44 then slidably engages the hollow tubular element 40 of vibration reducing grip 10 and securely engages the vibration reducing coupling 50 housed within the handlebar end 42 of the handlebar assembly link 24. In operation, shock and vibration emanating through from the handlebar assembly 12 and through a vibration reducing coupling 50 on to a connection rod 44 reduced.

Although the present invention has been described hereinabove by way of specific embodiments thereof, it can be modified, without departing from the spirit and nature of the subject invention. For example, such a vibration reducing grip described herein could be used as a hand grip whenever vibration dampening is needed for other construction equipment such as power trowels, concrete saws, and hand held or walk behind dirt and asphalt compactors. Furthermore, applications for such a vibration reducing grip may also include any situation where a vibrating handle bar needs to be grasped by a user such as is the case, for instance, for power tools, motorcycles, bicycles, and lawnmowers.

1. A vibration reducing grip for a handle bar comprising:
an outer tubular element;
an inner tubular element disposed within said outer tubular element; and
a vibration reducing coupling comprising a plurality of deformable ribs for coupling said inner tubular element and said outer tubular element;
wherein vibration imparted from the handle bar is reduced by the deformation of the vibration reducing coupling.

2. The vibration reducing grip of claim 1, wherein said plurality of deformable ribs are radially disposed and longitudinal the length of said tubular elements.

3. The vibration reducing grip of claim 1, further comprising a plurality of sealed gas compartments formed from said plurality of deformable ribs and said inner tubular and outer tubular elements wherein vibration imparted from the handle bar is reduced by the deformation of said compartments and the compression of said gas therein.

4. The vibration reducing grip of claim 3, wherein said sealed gas is air.

5. The vibration reducing grip of claim 1, wherein said outer tubular element is tapered.

6. The vibration reducing grip of claim 1, wherein said inner tubular comprises a metallic material.

7. The vibration reducing grip of claims 1, wherein said outer tubular element comprises a vibration reducing material such as synthetic rubber, natural rubber, thermoplastic elastomers, thermoplastic resins, polyester, elastomer and plastic reinforced textiles, and polyurethane.

8. The vibration reducing grip of claim 1, wherein said vibration reducing coupling is composed of vibration reducing material such as synthetic rubber, natural rubber, thermoplastic elastomers, thermoplastic resins, polyester, elastomer and plastic reinforced textiles, and polyurethane.

9. A vibration reducing connector for connecting a handle bar to a vibration reducing grip comprising a vibration reducing grip comprising an outer tubular element, an inner tubular element disposed within said outer tubular element, and a first vibration reducing coupling comprising a plurality of deformable ribs for coupling said inner tubular element and said outer tubular element comprising:
a rod comprising a first end and a second end; and
a second vibration reducing coupling housed within said handlebar and capable of securely receiving the first end of said rod;
wherein said first end of said rod slidably engages the inner tubular element and the vibration reducing coupling to securely connect the handlebar to the vibration reducing grip.

10. The vibration reducing connector of claim 9, further comprising a rod comprising a flanged second end wherein when said first end of said rod slidably engages the inner tubular element and the vibration reducing coupling said flange abuts the vibration reducing grip to securely connect the handlebar to the vibration reducing grip.

11. The vibration reducing connector of claim 10, wherein the vibration reducing coupling comprises a vibration reducing material such as s synthetic rubber, natural rubber, thermoplastic elastomers, thermoplastic resins, polyester, elastomer and plastic reinforced textiles, and polyurethane.
